(19) United States
(12) Patent Application Publication
(10) Pub. No.: US 2025/0042406 A1
(43) Pub. Date: Feb. 6, 2025

(54) Method and System for Detecting an Occurrence of a Predetermined Driving Situation During a Journey Using an Activated Driver Assistance System

(71) Applicant: Bayerische Motoren Werke Aktiengesellschaft, Muenchen (DE)

(72) Inventors: Benjamin MEENE, Muenchen (DE); Thomas VELTEN, Siegsdorf (DE)

(21) Appl. No.: 18/719,901

(22) PCT Filed: Dec. 13, 2022
(86) PCT No.: PCT/EP2022/085475

§ 371 Date: Jun. 14, 2024

(30) Foreign Application Priority Data
Dec. 16, 2021 (DE) 10 2021 133 443.8

(51) Int. Cl. B60W 30/18; B60W 30/16; B60W 50/14

(52) U.S. Cl. CPC B60W 30/18163; B60W 30/16; B60W 50/14; B60W 2050/146; B60W 2552/10; B60W 2554/4041; B60W 2554/4043; B60W 2554/4045

(57) ABSTRACT

A method is provided for detecting an occurrence of a predetermined driving situation and for identifying a start time and an end time of the predetermined driving situation for a journey using an activated driver assistance system for longitudinal control of an ego vehicle. The method includes detecting a potential occurrence of the predetermined driving situation and identifying the start time if a predetermined initial condition is satisfied, detecting the occurrence of the predetermined driving situation if the potential occurrence of the predetermined driving situation has been detected and a predetermined condition is satisfied, and detecting an end of the occurrence of the predetermined driving situation and identifying the end time if the occurrence of the predetermined driving situation has been detected and a predetermined end condition is satisfied.

### BACKGROUND AND SUMMARY

The present invention relates to a method for detecting an occurrence of a predetermined driving situation and for identifying a start time and an end time of the predetermined driving situation during a journey using an activated driver assistance system for longitudinal control of an ego vehicle, to a system for data processing which is designed to perform the method at least partially, to a computer program, comprising commands which, when the program is run by a computer, cause the computer to perform the method at least partially, and to a computer-readable medium, comprising commands which, when executed by a computer, cause the computer to perform the method at least partially.

A challenge in the area of the development of assisting and automated driving functions is the assessment of the system performance with various development stages. Ultimately, such systems claim to meet customers' expectations. Especially in the case of comfort-based driver assistance systems, however, the meeting of expectations is dominated by subjective impressions. Establishing the subjective and objective performance of a system during development is usually enabled by defining certain situations which are intended to replicate the overall system behavior in complex real-world traffic on the basis of a specific driving event and on the basis of which the system performance is determined in the course of regular assessment trips.

One disadvantage of the prior art is that these situations cannot be recorded, or not reliably, in an automated manner on the basis of sensor data of the on-board sensor system, i.e. on the basis of the sensor system already fitted in the ego vehicle, which is also used by the driver assistance system.

Against the background of this prior art, the object of the present invention is to provide a device and a method suitable for overcoming at least the aforementioned disadvantages of the prior art.

The object is achieved by the claimed invention.

Accordingly, the object is achieved by a method for detecting an occurrence of a predetermined driving situation and for identifying a start time and an end time of the predetermined driving situation for a journey using an activated driver assistance system for longitudinal control of an ego vehicle.

The method may be applied both live during a journey (i.e. while the driver assistance system is active) but also after the journey on the basis of recorded data.

The method comprises detecting a potential occurrence of the predetermined driving situation and identifying the start time if a predetermined initial condition is satisfied.

Subsequently, the method comprises detecting the occurrence of the predetermined driving situation if the potential occurrence of the predetermined driving situation has been detected and a predetermined condition is satisfied.

The method also comprises detecting an end of the occurrence of the predetermined driving situation and identifying the end time if the occurrence of the predetermined driving situation has been detected and a predetermined end condition is satisfied.

To be more precise, a method for recording the (driving) situation that can proceed as follows may be provided: if all of the initial conditions of a situation are satisfied (potentially relevant situation), a timer which records the time that has elapsed since its initial activation starts. The state of a potentially relevant situation indicates that the current traffic situation could develop into a relevant situation, but may not necessarily do so. Moreover, the recorded signals could still contain errors or be incorrect, and so in reality there could not be a situation at all. From this time on, it is checked cyclically whether in fact a relevant situation develops. Up to this time, the situation can be newly started if another object satisfies the initial conditions. As soon as a situation actually becomes relevant (the state of a relevant situation), this will continue until at least one of the end conditions (according to the situation description, see below) is satisfied. Only then can an optional retrospective assessment of the recorded situation take place. For this purpose, signals/data contained in the measuring buffer are used-they therefore do not have to be stored as a precaution for every potential situation but can be retrieved as and when required, which reduces the runtime and the storage requirement.

The automated recording can undertake the task previously carried out by the driver. This is intended to ensure that all predetermined situations are recorded and any variance due to subjective driver perception is prevented.

With the method, situations (or partial situations) can be identified or replaced by others in an automated manner on the basis of criteria and parameters. This method does not require any additional reference measuring technology, since it considers the event/the situation over a longer time period to validate the situation.

This method can proceed in real time and offer the driver/developer the possibility of situation appraisal (and possibly also serve for training the subjective perception for new drivers) even during the journey.

There follows a situation description of possible predetermined driving situations (initial conditions of the respective situation are described in detail later and are not included here).

Adjacent lane interference (ALI): adjacent lane interference describes a vehicle reaction that is implausible to the driver in response to an object which the driver would not consider to be a target object (TO, object in response to which control by way of the driver assistance system takes place). The vehicle reaction must be perceptible at least in the form of an implausible TO indication, for example on the instrument cluster, and possibly additionally causes braking.

The conditions for the state of a “relevant situation”, i.e. for the case where the method detects relevant adjacent lane interference, can be set out as follows: the object that satisfied the initial condition is no longer recorded as relevant for control by the sensor system, the object that satisfied the initial condition is entirely and permanently no longer recorded by the sensor system, or the TO indication on the instrument cluster goes out.

The end conditions for the driving situation of adjacent lane interference can be set out as follows: the end condition is satisfied if at the latest after a predetermined time period, for example five seconds, after the state of a “relevant situation” arose, if there is only one-off adjacent lane interference, the end condition is satisfied after at most the predetermined time period after a final non-recording of the object (in the case of repeatedly occurring ALIs in response to the same object), or the end condition is satisfied if an intervention by the driver in the longitudinal movement (accelerating or braking) or a deactivation of the system takes place.

Loss of target object (LTO): a loss of target object describes a deselection of the target object following behind that is implausible to the driver. This includes both instances of constant driving and accelerating and braking operations with target objects. Losses of target objects can be perceived by the TO indication on the instrument cluster going out; a LTO possibly additionally causes acceleration of the ego vehicle.

The conditions for the state of a “relevant situation”, i.e. for the case where the method detects a relevant loss of target object, can be set out as follows: the object that satisfied the initial condition is recorded once again as a target object by the sensor system within a predetermined time period, for example of two seconds, or the indication of an object on the instrument cluster is activated.

The end conditions for the driving situation of a loss of target object can be set out as follows: the end condition is satisfied at the earliest after a predetermined time period, for example two seconds, after the state of a “relevant situation” arose (in the case of long losses of the object, the time period can be extended), or the end condition is satisfied if an intervention by the driver in the longitudinal movement (accelerating or braking) or deactivation of the system takes place.

Approach: an approach describes the approach of the ego vehicle to new target objects in the ego lane. The situation of an approach is divided into driving objects and stationary objects in order to assess approaches to stopped/a priori stationary objects independently of driving objects. In the case of a stationary object being approached, the stopping operation of the ego vehicle is additionally assessed.

The condition for the state of a “relevant situation”, i.e. for the case where the method detects a relevant approach, may exist if the control begins in response to the object that previously satisfied the initial conditions.

The end conditions for the driving situation of an approach can be set out as follows: the target distance from the object is established, the TO accelerates away, the TO moves out of the lane (detection by the state of a “relevant situation” of the TO vehicle moving out of lane), a third object moves into the lane (relevant situation of a vehicle moving into lane), ego change of lane: flashing or relevant situation of the ego vehicle changing lane, or the ego vehicle is stationary, the TO is not recorded for longer than a predetermined time period, for example 800 ms (sum during the entire recording operation of the situation), an intervention by the driver in the longitudinal movement (accelerating or braking) or a deactivation of the system takes place, or more than a predetermined time period, for example of 30 seconds, has elapsed since detection of the initial condition.

Vehicle moving into lane: this involves assessing the reaction of the ego vehicle to vehicles that come from an adjacent lane in parallel and move into the lane ahead of the ego vehicle below a predefined target recording distance. The reaction to all vehicles moving into the lane is to be assessed, independently of whether or not they have been detected as such by the environment model. The predefined target recording distance may be defined as the longitudinal distance below which it is expected for the sensor system fitted in the vehicle to detect the vehicles ahead of the ego vehicle.

The conditions for the state of a “relevant situation”, i.e. for the case where the method detects a relevant vehicle moving into the lane, can be set out as follows: a reaction (braking intervention or indication of the object on the instrument cluster) of the ego vehicle to the object that previously satisfied the initial conditions takes place, or the object that previously satisfied the initial conditions is in the driving path of the ego vehicle for at least a predetermined time period, for example 500 milliseconds.

The end conditions for the driving situation of a vehicle moving into lane can be set out as follows: the target distance from the object is established, the TO accelerates away, the TO moves out of the lane (detection by the state of a “relevant situation” of the TO vehicle moving out of lane), a third object begins to move into the lane (detection by environment model/sensor system), ego change of lane: flashing or relevant situation of the ego vehicle changing lane, the ego vehicle is stationary, an intervention by the driver in the longitudinal movement (accelerating or braking) or a deactivation of the system takes place, or more than a predetermined time period (for example of 30 seconds) has elapsed since detection of the initial condition.

Target object vehicle moving out of lane: a target object below a predefined target recording distance leaves the lane while driving behind (for changing lane or turning off). In this case, only the deselection of the target object is assessed. The predefined target recording distance may be defined as the longitudinal distance below which it is expected for the sensor system fitted in the vehicle to detect the vehicles ahead of the ego vehicle.

The conditions for the state of a “relevant situation”, i.e. for the case where the method detects a relevant target object vehicle moving out of the lane, can be set out as follows: a reaction of the ego vehicle to the object moving out of the lane that previously satisfied the initial conditions takes place within 2 seconds after the initial condition, or the object that previously triggered the initial conditions is no longer in the driving path of the ego vehicle and exceeds a predetermined transverse distance, for example of 2 meters.

The end conditions for the driving situation of a target object vehicle moving out of lane can be set out as follows: control in response to a new object begins, the ego vehicle is driving freely (no target object) and at least a predetermined time period, for example of 400 ms, has elapsed since the state of a “relevant situation” arose, a third object moves into the lane (relevant situation of a vehicle moving into lane), ego change of lane: flashing or relevant situation of the ego vehicle changing lane, the ego vehicle is stationary, an intervention by the driver in the longitudinal movement (accelerating or braking) or a deactivation of the system takes place, or more than a predetermined time period, for example of 30 seconds, has elapsed since detection of the initial condition.

Ego vehicle moving out of lane/changing lane: in this situation, the ego vehicle carries out a change of lane and leaves the lane. Only changes of lane from driving behind in the direction of overtaking are assessed.

The conditions for the state of a “relevant situation”, i.e. for the case where the method detects a relevant ego vehicle moving out of the lane/changing lane, can be set out as follows: the control in response to the object in the adjacent lane is no longer active, but at least a predetermined time period, of for example 400 ms, since the beginning of the “potentially relevant situation” must have elapsed, or the previously present target object is deselected after the beginning of the “potentially relevant situation” (is consequently no longer a TO), at the earliest after a predetermined time period, of for example 400 ms, after the beginning of the “potentially relevant situation”, or the ego vehicle detects a guardrail/roadway structure in the directly adjacent lane, at the earliest after a predetermined time period, of for example 600 ms, after the beginning of the “potentially relevant situation”.

The end conditions for the driving situation of an ego vehicle moving out of lane/changing lane can be set out as follows: if there is a free target lane (the lane to be entered when changing lane is clear): the old TO was deselected and the flashing indicator deactivated (at the earliest after a predetermined time period of for example 8 seconds), if there is a new object in the target lane (an object is driving in the lane to be entered when changing lane): the object in the target lane is then the target object of the control and the flashing indicator has been deactivated (at the earliest after a predetermined time period of for example 2 seconds), the ego vehicle is stationary, an intervention by the driver in the longitudinal movement (accelerating or braking) or a deactivation of the system takes place, or more than a predetermined time period (for example of 30 seconds) has elapsed since detection of the initial condition.

Specifically applied to the situation of an “approach” with activated adaptive cruise control (ACC) to a stationary object, the method can proceed as follows: here, the recording process according to the method has three stages. First, a “potential approach” in the case of the first recording of a new object ahead of the ego vehicle (initial condition), which could however also be a false detection in an adjacent lane. Furthermore, in a second step, at the beginning of the control by the adaptive cruise control (predetermined condition), the “safe approach” is detected and possibly output in a tool. Lastly, the approach is ended on the basis of further criteria (target distance adjusted, other situation, . . . ) (end condition).

The method may be a computer-implemented method. The method may be implemented by way of an algorithm which records the predetermined situation, in particular a number of predetermined situations, during the journey in an automated manner exclusively on the basis of the signals present in the ego vehicle and optionally performs an assessment retrospectively following the recording. This optional assessment of the recorded situation made in this case take place on the basis of predetermined, possibly situation-specific criteria which assess a subjective driver's impression as objectively as possible.

Such an automated and thereby objectified recording of a situation allows increased comparability of (test) trips with the ego vehicle and also more reliable identification of the predetermined situation(s) to be achieved. This can make possible a situation assessment which establishes the system performance of the driver assistance system of the ego vehicle, for example during its development, as objectively and free from subjective impressions as possible. This also improves the comparability of different software statuses of the entire active chain of the driver assistance system.

Developments of the method described above are described in detail below.

The end condition may be satisfied if a predetermined time period, for example 30 seconds, has elapsed since the identification of the start time.

The method may be terminated if during the potential occurrence of the predetermined driving situation the occurrence of a further, in particular other, predetermined driving situation is detected.

That is to say that, for the automated recording of the (driving) situations described above, depending on the situation a function which is performed cyclically during the journey may be implemented. All of the functions for recording a situation may for example be called up from a main function which controls the functions to be called up and possibly records additional, trans-situational information such as deactivations of the system or the type of road. The fact that, for each situation, a single function undertakes the recording ensures that a recording of different situations in parallel is possible. The recording of a situation is in this case based purely on the vehicle-internal signals (signals on the vehicle buses and in the control unit), and no interaction on the part of the driver is necessary. Since the different situations partially depend on one another (for example an approach is immediately ended when a situation of a vehicle moving into lane or a vehicle moving out of lane begins), the performance of the method is advantageous if all situations are active and are recorded.

The detection of the occurrence of the predetermined driving situation and the identification of the start time and the end time of the predetermined driving situation may take place on the basis of sensor data that are used by the driver assistance system for longitudinal control.

The driver assistance system may be an adaptive cruise control. An adaptive cruise control is a speed control system in motor vehicles, in particular automobiles, which, when controlling a speed of the motor vehicle, includes a distance from a vehicle driving ahead as an additional feedback variable and controlled variable. The adaptive cruise control belongs to the driver assistance systems, i.e. the adaptive cruise control may be one of a number of driver assistance systems or the only driver assistance system fitted in the motor vehicle for longitudinal control. The adaptive cruise control (ACC) may also be referred to as automatic distance regulation (ADR). The adaptive cruise control may be part of a (for example radar-based) emergency braking assistant and/or have a stop-and-go function.

The initial condition may be satisfied if: control by way of the driver assistance system in response to an object in response to which previously no control by way of the driver assistance system took place starts, an indication of an object on a display of the ego vehicle that was previously not active is activated by way of the driver assistance system, control by way of the driver assistance system in response to an object in response to which previously control by way of the driver assistance system took place is ended, an indication of an object on a display of the ego vehicle that was previously active is deactivated by way of the driver assistance system, an object ahead of the ego vehicle in response to which previously no control by way of the driver assistance system took place and which has a lower longitudinal speed than the ego vehicle that is not opposite to a longitudinal speed of the ego vehicle is recorded, an object is classified as a vehicle moving into the lane by way of an environment model used by the driver assistance system, an active direction indicator, pointing in the direction of the ego vehicle, of an object in an adjacent lane is detected, an object in an adjacent lane comes closer to a driving path of the ego vehicle than a predetermined transverse distance and has a transversal speed in the direction of the ego vehicle, an object in response to which control by way of the driver assistance system is currently taking place is classified as a vehicle moving out of the lane by way of an environment model used by the driver assistance system, an active direction indicator of an object in response to which control by way of the driver assistance system is currently taking place is detected, an object in response to which control by way of the driver assistance system is currently taking place exceeds a predetermined transverse distance from a center of a driving path of the ego vehicle and has a transversal speed leading away from the ego vehicle, the ego vehicle activates its direction indicator in the direction of a clear adjacent lane as long as the ego vehicle is following behind another vehicle and/or an object is driving in the clear adjacent lane, and/or the ego vehicle performs a steering movement such that a driving path of the ego vehicle passes by the object in response to which control by way of the driver assistance system is currently taking place.

These initial conditions can be expressed more specifically as set out below and respectively assigned as follows to one of the driving situations described above:

Adjacent lane interference (ALI): beginning of control in response to a new object to which no control took place in the cycle before (in the ego lane or in the adjacent lane), or activation of the indication of an object that was not previously active in the cycle on the instrument cluster.

Loss of target object (LTO): ending of control in response to an object in response to which control took place in the cycle before (in the ego lane or in a lane relevant to overtaking prevention (this function prevents slower-driving vehicles from overtaking on the right in the case of right-hand traffic)), or deactivation of the indication of an object that was active in the cycle before on the instrument cluster.

Approach: recording an object ahead of the ego vehicle in response to which previously no control took place and which has a lower longitudinal speed than the ego vehicle that is not opposite to that of the ego vehicle (not an oncoming object).

Vehicle moving into lane: an object is marked by the environment model (EM) as a vehicle moving into lane, or the environment model detects an active direction indicator of an object in an adjacent lane as long as the flashing is pointing in the direction of the ego vehicle, or an object in the adjacent lane comes closer to the ego driving path than a determined transverse distance and has a transversal speed in the direction of the ego vehicle.

Target object vehicle moving out of lane: the current target object is marked by the environment model as a vehicle moving out of lane, or the environment model detects an active direction indicator of the target object, or the target object exceeds a certain transverse distance from the center of the ego driving path and has a transversal speed leading away from the ego vehicle.

Ego vehicle moving out of lane/changing lane: the ego vehicle flashes in the direction of a clear adjacent lane as long as the ego vehicle is following behind another vehicle and/or an object is driving in the clear adjacent lane, or the ego vehicle performs a steering movement such that the driving path passes by the current target object.

A device for data processing is also provided, the device for data processing comprising an apparatus for performing the method described above.

The device for data processing may have a computing device, in particular an electronic control unit (ECU), which is fitted on the motor vehicle. The device for data processing may however also be an external device, such as a personal computer, or have such a device. The device for data processing may have an output interface fitted on the motor vehicle. The output interface fitted on the motor vehicle may be connected to the computing device and make it possible for the vehicle-external part of the device for data processing to obtain the signals/data on the motor vehicle necessary for performing the method.

The device for data processing may have an intelligent processor-controlled unit which can communicate with other modules, for example via a central gateway (CGW), and/or the device may form an on-board network of the vehicle, for example via fieldbuses such as the CAN bus, LIN bus, MOST bus and FlexRay and/or via automotive Ethernet, possibly together with one or more telematic control units. The device for data processing may be designed to control functions relevant to the handling properties of the motor vehicle, such as an engine controller, a power transmission, a braking system and/or a tire-pressure monitoring system. In addition or as an alternative, some or all of the driver assistance systems, such as for example a parking assistant, adaptive cruise control (ACC), lane-keeping assistant, lane-changing assistant, traffic-sign recognition, traffic-signal recognition, start-up assistant, night-vision assistant and/or intersection assistant, may be controlled by the device.

Furthermore, a motor vehicle, in particular an automobile, which has the device for data processing described above may be provided as the ego vehicle, the device for data processing comprising an apparatus for performing the method.

The motor vehicle may be automated. The automated motor vehicle may be designed to undertake transverse and/or longitudinal guidance at least partially and/or for a time during automated driving of the motor vehicle. This can be controlled, in particular in a closed-loop manner, by way of the driver assistance system.

The automated driving may take place such that the movement of the motor vehicle takes place (largely) autonomously. The motor vehicle may be a motor vehicle of autonomy level 1, i.e. have certain driver assistance systems that assist the driver in operating the vehicle, for example adaptive cruise control (ACC).

The motor vehicle may be a motor vehicle of autonomy level 2, i.e. be partially automated such that functions such as automatic parking, lane keeping or transverse guidance, general longitudinal guidance, accelerating and/or braking are undertaken by driver assistance systems.

The motor vehicle may be a motor vehicle of autonomy level 3, i.e. conditionally automated such that the driver does not have to constantly monitor the vehicle system. The motor vehicle itself independently carries out functions such as operating the flashing turn indicator, changing lane and/or keeping in lane. The driver can pay attention to other things but as and when required is prompted by the system to take over guidance of the vehicle within an advance warning time.

The motor vehicle may be a motor vehicle of autonomy level 4, i.e. so highly automated that guidance of the vehicle is permanently undertaken by the vehicle system. If the driving tasks can no longer be managed by the system, the driver may be prompted to take over guidance.

The motor vehicle may be a motor vehicle of autonomy level 5, i.e. so fully automated that the driver is not needed to perform the driving task. Apart from establishing the destination and starting the system, no human intervention is needed. The motor vehicle can then function without a steering wheel and pedals.

The autonomy levels described above may correspond to those of SAE J3016.

The above description with respect to the method also applies here analogously to the device for data processing and the motor vehicle, and vice versa.

A computer program or a computer-readable (storage) medium, comprising commands which, when the program is run by a computer, cause the computer to perform the method described above is also provided.

The computer program or the computer-readable (storage) medium may in this case comprise commands in the form of a program code which, when it is run on a computing unit or computing device, performs the above method. The program code may take the form of any code, in particular a code which is suitable for processing in a motor vehicle. The computer-readable storage medium, which comprises a computer program defined above, may be any digital data storage device, such as for example a USB stick, a hard disk, a CD-ROM, an SD card and/or an SSD card. The computer program may however additionally or alternatively also be obtained in some other way, for example via the Internet.

The above description with respect to the method, the device for data processing and the motor vehicle also applies here analogously to the computer program and the computer-readable medium, and vice versa.

An embodiment is described below with reference to FIGS. 1 and 2.

### BRIEF DESCRIPTION OF THE DRAWINGS

FIG. 1 schematically shows a flow diagram of a method for detecting an occurrence of a predetermined driving situation and for identifying a start time and an end time of the predetermined driving situation during a journey using an activated driver assistance system for longitudinal control of an ego vehicle.

FIG. 2 schematically shows by way of example a number of driving situations to which the method from FIG. 1 is applied.

### DETAILED DESCRIPTION OF THE DRAWINGS

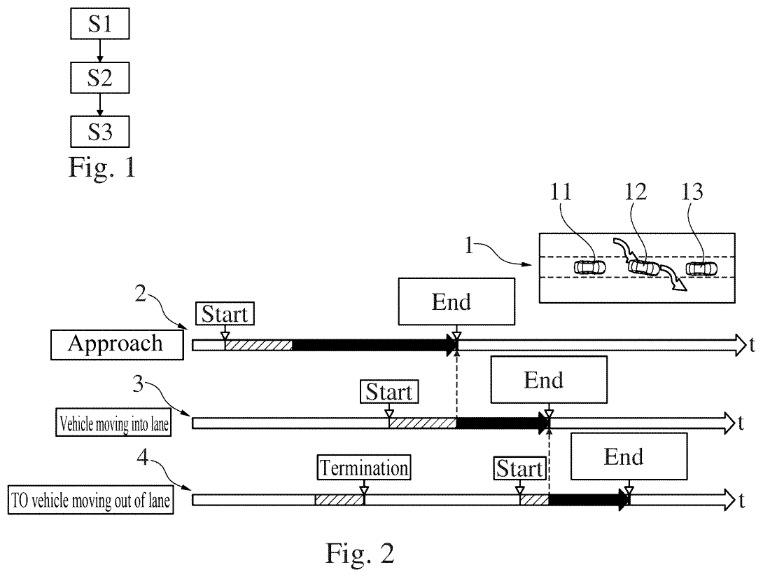

As can be seen from the flow diagram of FIG. 1, the method for detecting an occurrence of a predetermined driving situation and for identifying a start time and an end time of the predetermined driving situation during a journey using an activated driver assistance system for longitudinal control of an ego vehicle substantially comprises three steps S1-S3.

The method is performed in parallel and in each case for a plurality of different predetermined driving situations by a system or a device for data processing which uses as input data for the method signals comprising sensor data that are used by the driver assistance system for longitudinal control. Here, the driver assistance system is adaptive cruise control.

Detecting the occurrence of the predetermined driving situation and identifying the start time and the end time of the predetermined driving situation are based on these sensor data, i.e. no additional reference measuring technology is used.

In a first step S1 of the method, detection of a potential occurrence of the predetermined driving situation and identification of the start time of the driving situation take place if a predetermined initial condition is satisfied. The method is terminated for the respective potentially occurring driving situation if during the potential occurrence of the predetermined driving situation the occurrence of a further predetermined driving situation is detected on the basis of the criteria of a second step S2 of the method (see below).

In the second step S2 of the method, detection of the occurrence of the predetermined driving situation takes place if the potential occurrence of the predetermined driving situation has been detected and a predetermined condition is satisfied.

In a third step S3 of the method, detection of an end of the occurrence of the predetermined driving situation and identification of the end time take place if the occurrence of the predetermined driving situation has been detected and a predetermined end condition is satisfied. The end condition may be satisfied if a predetermined time period has elapsed since the identification of the start time.

This method is now described in detail with reference to FIG. 2, in which, for purposes of explanation and by way of example, a number of successive driving situations are shown in a window 1, as well as three parallel-running algorithms/functions 2, 3, 4, which in each case perform the method described above with reference to FIG. 1 for a respective predetermined driving situation.

The function 2 shown at the top is designed to record the predetermined driving situation of an “approach” described at the beginning. The function 3 shown in the middle is designed to record the predetermined driving situation of a “vehicle moving into lane” described at the beginning. The function 4 shown at the bottom is designed to record the predetermined driving situation of a “TO vehicle moving out of lane” described at the beginning. These three functions are only shown by way of example and the device for data processing performing the method is designed also to perform in parallel the further functions described at the beginning. For each of the functions 2, 3, 4, FIG. 2 shows a timeline t, on the basis of which the various steps of the method are illustrated with reference to the driving situations shown in FIG. 1.

Firstly, the ego vehicle 11 (see window 1) approaches a vehicle 13 driving ahead. The adaptive cruise control of the ego vehicle 11 records the vehicle 13 driving ahead, in response to which previously no control took place and which has a lower longitudinal speed than the ego vehicle 11, the direction of which corresponds to that of the ego vehicle 11 or is not opposite to it (i.e. the vehicle 13 is not an oncoming object). The system for data processing performing the function 2, which is in the ego vehicle 11 and obtains the signals of the ego vehicle 11, therefore establishes in the first step S1 of the method that the initial condition for the driving situation of an “approach” is satisfied. The function 2 therefore detects the potential occurrence of the driving situation of an “approach” (see dashed marking in the timeline for function 2 in FIG. 1) and identifies or sets the start time for the driving situation of an “approach” as soon as the initial condition is satisfied.

The function 2 then checks cyclically whether one of the other functions 3, 4 detects its respective driving situation. If this is the case, the function 2 would terminate the method and begin afresh. The potential occurrence of the driving situation of an “approach” would be rejected. Furthermore, the function 2 checks cyclically whether a predetermined condition in addition to the initial condition is satisfied, i.e. in the case of the driving situation of an “approach” whether an intervention (for example by braking) in the longitudinal guidance of the ego vehicle 11 takes place. As soon as this takes place, a status of the identification of the driving situation of an “approach” changes from potential to detected, i.e. the occurrence of the predetermined driving situation is finally detected (see in this respect the solid marking in the timeline for function 2 in FIG. 1).

If, however, before that the occurrence of the initial condition no longer applies and/or the occurrence of this condition does not take place within a predetermined time period, the function 2 would have terminated the method after the first step S1, as is the case for example initially with the function 4 provided for the driving situation of a “TO vehicle moving out of lane”. The vehicle 13 driving ahead, which at this time serves as the target object for the adaptive cruise control, performs a transverse movement in the direction of an adjacent lane and thereby exceeds a certain transverse distance from the center of the ego driving path of the ego vehicle 11 and initially has a transversal speed leading away from the ego vehicle 11. The function 4 therefore detects the potential occurrence of the driving situation of a “TO vehicle moving out of lane” (see dashed marking in the timeline for function 4 in FIG. 1). However, no change of lane by the vehicle 13 driving ahead takes place and the transversal speed of the vehicle 13 goes to zero (i.e. there is no transversal speed any longer), and so the initial condition for the driving situation of a “TO vehicle moving out of lane” no longer applies and the function 4 terminates the method after the first step S1, before the driving situation of a “TO vehicle moving out of lane” can be finally detected in the second step S2 of the method.

After the second step S2 of the method, i.e. if the (final) occurrence of the predetermined driving situation has been detected, the function 2 carries out the third step S3 of the method in order to detect an end of the occurrence of the predetermined driving situation of an “approach” and to set/identify the end time. The end of the occurrence of the predetermined driving situation of an “approach” is detected and the end time is set as soon as the predetermined end condition of the driving situation of an “approach” is satisfied, i.e. as soon as the distance from the vehicle 13 driving ahead is adjusted. The end condition may however also be satisfied if a predetermined time period has elapsed since the identification of the start time.

Once the end time has been identified by way of the function 2, in the present case a seamless transition to the driving situation of a “vehicle moving into lane” takes place, as can be seen for the function 3. Already before the end time of the function 2, the occurrence of the initial condition for the driving situation of a “vehicle moving into lane” has been detected by the function 3 in the first step S1 of the method. In the present case, the vehicle 12 initially located in the adjacent lane is not marked by the environment model of the ego vehicle 11 as a vehicle moving into the lane, but the initial condition is nevertheless satisfied since the vehicle 12 comes closer to the ego driving path than a predetermined transverse distance and has a transversal speed in the direction of the ego vehicle 11. The function 3 therefore detects the potential occurrence of the driving situation of a “vehicle moving into lane” (see dashed marking in the timeline for function 3 in FIG. 1). The start time is set correspondingly.

Subsequently, in the second step S2 of the method, it is detected by the function 3 that a change of lane of the vehicle 12 to the ego lane has taken place and the driving situation of a “vehicle moving into lane” is detected as such (see solid marking in the timeline for function 3 in FIG. 1).

Subsequently, in the third step S3 of the method, it is detected by the function 3 that the vehicle 12 that moved into the lane leaves the ego lane again, and so the end condition for the driving situation of a “vehicle moving into lane” is satisfied. The end time is set/identified correspondingly.

After the end time has been identified by way of the function 3, here too a seamless transition to the driving situation of a “TO vehicle moving out of lane” takes place, as can be seen for the function 4. Already before the end time of the function 3, the occurrence of the initial condition for the driving situation of a “TO vehicle moving out of lane” has been detected by the function 4 in the first step S1 of the method (see above) (see dashed marking in the timeline for function 4 in FIG. 1). Subsequently, in the second step S2 of the method, it is detected by the function 4 that a change of lane of the vehicle 12 to the adjacent lane has actually taken place and the driving situation of a “TO vehicle moving out of lane” is detected as such (see solid marking in the timeline for function 4 in FIG. 1). Subsequently, in the third step S3 of the method, it is detected by the function 4 that the vehicle 13 driving ahead is (again) the target object in response to which control is taking place, and so the end condition for the driving situation of a “TO vehicle moving out of lane” is satisfied. The end time is set/identified correspondingly.

### LIST OF REFERENCE SIGNS

1 Driving situation
11 Ego vehicle
12 Vehicle moving into lane and moving out of lane
13 Original vehicle driving ahead in ego lane
2 Function for the driving situation of an “approach”
3 Function for the driving situation of a “vehicle moving into lane”
4 Function for the driving situation of a “vehicle moving out of lane”
S1-S3 Method steps
t Time

1.-10. (canceled)

11. A method for detecting an occurrence of a predetermined driving situation and for identifying a start time and an end time of the predetermined driving situation for a journey using an activated driver assistance system for longitudinal control of an ego vehicle, the method comprising:
detecting a potential occurrence of the predetermined driving situation and identifying the start time if a predetermined initial condition is satisfied,
detecting an occurrence of the predetermined driving situation when the potential occurrence of the predetermined driving situation has been detected and a predetermined condition is satisfied, and
detecting an end of the occurrence of the predetermined driving situation and identifying the end time when the occurrence of the predetermined driving situation has been detected and a predetermined end condition is satisfied.

12. The method according to claim 11, wherein the end condition being satisfied when a predetermined time period has elapsed since identification of the start time.

13. The method according to claim 11, wherein the method is terminated when during the potential occurrence of the predetermined driving situation, an occurrence of a further predetermined driving situation is detected.

14. The method according to claim 11, wherein detecting the occurrence of the predetermined driving situation and identifying the start time and the end time of the predetermined driving situation take place based on sensor data that are used by the driver assistance system for longitudinal control.

15. The method according to claim 11, wherein the driver assistance system is an adaptive cruise control.

16. The method according to claim 11, wherein the initial condition is satisfied when at least one of:
control by way of the driver assistance system starts in response to an object in response to which previously no control by the driver assistance system took place,
an indication of an object on a display of the ego vehicle that was previously not active is activated by way of the driver assistance system,
control by way of the driver assistance system in response to an object in response to which previously control by way of the driver assistance system took place is ended,
an indication of an object on a display of the ego vehicle that was previously active is deactivated by way of the driver assistance system,
an object ahead of the ego vehicle in response to which previously no control by way of the driver assistance system took place and which has a lower longitudinal speed than the ego vehicle that is not opposite to a longitudinal speed of the ego vehicle is recorded,
an object is classified as a vehicle moving into the lane by way of an environment model used by the driver assistance system,
an active direction indicator, pointing in a direction of the ego vehicle, of an object in an adjacent lane is detected,
an object in an adjacent lane comes closer to a driving path of the ego vehicle than a predetermined transverse distance and has a transversal speed in the direction of the ego vehicle,
an object in response to which control by way of the driver assistance system is currently taking place is classified as a vehicle moving out of the lane by way of an environment model used by the driver assistance system,
an active direction indicator of an object in response to which control by the driver assistance system is currently taking place is detected,
an object in response to which control by way of the driver assistance system is currently taking place exceeds a predetermined transverse distance from a center of a driving path of the ego vehicle and has a transversal speed leading away from the ego vehicle,
the ego vehicle activates its direction indicator in a direction of a clear adjacent lane as long as the ego vehicle is following behind another vehicle and/or an object is driving in the clear adjacent lane, or
the ego vehicle performs a steering movement such that a driving path of the ego vehicle passes by the object in response to which control by way of the driver assistance system is currently taking place.

17. A system for data processing, comprising a device for performing the method according to claim 11.

18. An ego vehicle comprising the system for data processing according to claim 17.

19. A computer product comprising a non-transitory computer readable medium having stored thereon program code which, when executed on a computer, carries out the method according to claim 11.
